(19) United States
(12) Patent Application Publication
(10) Pub. No.: US 2022/0196407 A1
(43) Pub. Date: Jun. 23, 2022

(54) Method for indoor route planning and automatic marker making for indoor navigation using markers

(71) Applicant: KOREA NATIONAL UNIVERSITY OF TRANSPORTATION INDUSTRY - ACADEMY COOPERATION FOUNDATION, Chungcheongbuk-do (KR)

(72) Inventor: Hyun KIM, Seoul (KR)

(21) Appl. No.: 17/530,512

(22) Filed: Nov. 19, 2021

(30) Foreign Application Priority Data
Dec. 4, 2020 (KR) 10-2020-0168478

(51) Int. Cl. G01C 21/20; G01C 21/36

(52) U.S. Cl. CPC G01C 21/206; G01C 21/367; G01C 21/3623; G01C 21/3632

(57) ABSTRACT

Provided is a method for moving route planning and marker automatic making, including reading, by a computing device, a first map in which a north direction is marked to display the first map on a monitor, acquiring, by the computing device, a user input regarding an azimuth to change a direction indicated by an arrow icon to be displayed on the monitor based on the user input regarding the azimuth, acquiring, by the computing device, a user input regarding node creation to display two or more nodes in a state of being overlapped on the first map based on the user input regarding the node creation, acquiring, by the computing device, a user input regarding link creation to display an arrow-shaped link connecting between two nodes disposed on the monitor in a state of being overlapped on the first map based on the user input regarding the link creation, creating, by the computing device, a table of a first type of markers respectively corresponding to the two or more nodes displayed in the state of being overlapped on the first map and a second type of markers corresponding to links displayed in the state of being overlapped on the first map, and outputting, by the computing device, the first type of markers and the second type of markers in a form of an image file based on information included in the table to store the output markers in a storage device.

### CROSS-REFERENCE TO RELATED APPLICATION

This application claims priority to Korean Patent Application No. 10-2020-0168478 filed on Dec. 4, 2020 and all the benefits accruing therefrom under 35 U.S.C. § 119, the contents of which are incorporated by reference in their entirety.

### BACKGROUND

The present disclosure relates to a technology implemented using a server and a user terminal. The present disclosure supports a technology for guiding a way to a person who walks to a destination in a space where GPS is not possible to be used. The present disclosure particularly relates to a technology for an indoor moving route map designing. Further, the present disclosure relates to a technology for automatically generating an image included in a marker to be attached on the moving route.

Navigation devices used outdoors operate using GPS signals. However, it is difficult for GPS signals to flow indoors. Therefore, it is difficult to apply a vehicle navigation program to an indoor environment. In order to overcome the above-mentioned problem, complex technologies such as a WiFi fingerprint and a geomagnetic fingerprint have been introduced. However, the implementation cost is very high and the reliability is still low.

There are many indoor spaces, such as transit subway stations and complex shopping malls, which GPS signals do not enter but are contain complex routes. In fact, in buildings with complex indoor structures, there is a problem that passers-by may not accurately find a moving route. In particular, there is a problem that, in transit subway stations, and the like, to demand rapid movement, the delay time taken to search for such a moving route may cause personal or social losses.

In order to solve the above-mentioned problems, a marker that may be identified by the eyes of a passer-by and a camera of a user device may be installed on the floor of the indoor space. An application program for a smartphone may be provided which, when the marker is photographed by the user device, outputs an optimum route along which the passer-by has to move with respect to the marker in order for the passer-by to go to a destination input by the passer-by into the user device in advance. An example of such a technique is given in PCT/KR2019/006610.

In order for the above-described application program to operate, in relation to an indoor floor on which markers are to be installed, a moving route map indicating a route to be followed by passers-by has to be already designed, and in fact, markers on the route of the indoor floor have to be installed. In this case, tens to thousands of the markers may exist. These individual markers are not possible to be drawn by hand, and have to be created automatically. However, PCT/KR2019/006610 does not present a technique for automatically creating markers.

Navigation programs for vehicles in the related art use information about a road already built on the ground. In this case, the process of developing the navigation programs for vehicles is different from the process of designing a road for road construction.

Similarly, the process of developing a navigation program for indoor pedestrians presented in PCT/KR2019/006610 is different from the process of designing the route for construction of an indoor pedestrian guidance route. The indoor pedestrian guidance route may be visually expressed by markers installed at specific points on a virtual pedestrian flow route.

### SUMMARY

The present disclosure provides a technology related to a computer application program for designing an indoor pedestrian guidance route. The present disclosure also provides a technology for automatically creating markers to be attached to the designed indoor pedestrian guidance route.

### BRIEF DESCRIPTION OF THE DRAWINGS

FIGS. 1a to 1d show configurations of user interfaces displayed on a screen by an application program according to one embodiment of the present invention.

FIG. 2 illustrates a detailed configuration of the first map window.

FIG. 3 is an image illustrating an example of a map displayed by the first map window.

FIG. 4 illustrates a state in which a map, an arrow icon, and a scale display portion are displayed on the first map window in a state of being overlapped or superimposed.

FIG. 5 illustrates a detailed configuration of a node-link selection toolbar.

FIG. 6a illustrates an example of creating a total of two nodes. FIG. 6b illustrates an example of creating a toilet node, an information node, and an elevator node

FIG. 7a illustrates an example of a result obtained by creating one link with a direction between two nodes. FIG. 7b illustrates markers to be attached to a pair of nodes connected to each other by one link in FIG. 7a and markers to be attached to a route between the pair of nodes.

FIGS. 8a, 8b, and 8c illustrate a first basement floor, a second basement floor, and a third basement floor of a specific subway station, respectively.

FIG. 9a is a diagram for describing information indicated by a sub-window expressed on the monitor when an arbitrary node that has already been created is clicked. FIG. 9b is a diagram for explaining information indicated by a sub-window expressed on the monitor when an arbitrary link that has already been created is clicked.

FIG. 10a is a table showing information on maps selected by the user. FIG. 10b is a table showing information about each node created by the user. FIG. 10c is a table showing information about each link created by the user. FIG. 10d is a table showing information on markers automatically created by the application program based on nodes and links created by the user.

FIG. 11 illustrates an example of images of marker1 and marker6 among markers automatically created by the computing device based on information included in a marker table.

FIG. 12 is a flowchart showing a method for moving route planning and automatic marker making by a computing device, according to an embodiment of the present disclosure.

FIG. 13 is a block diagram of a computing device according to an embodiment of the present disclosure.

### DETAILED DESCRIPTION OF EMBODIMENTS

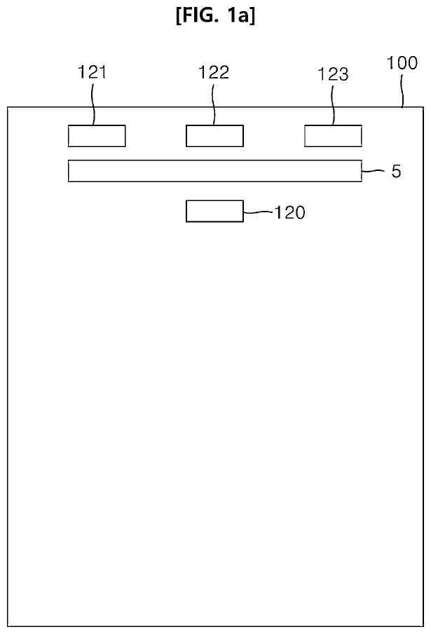

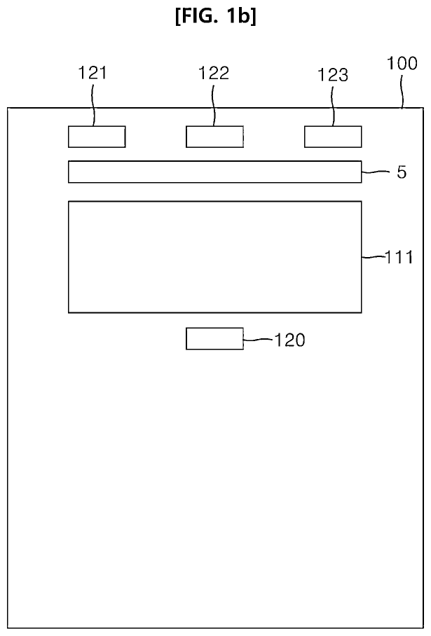

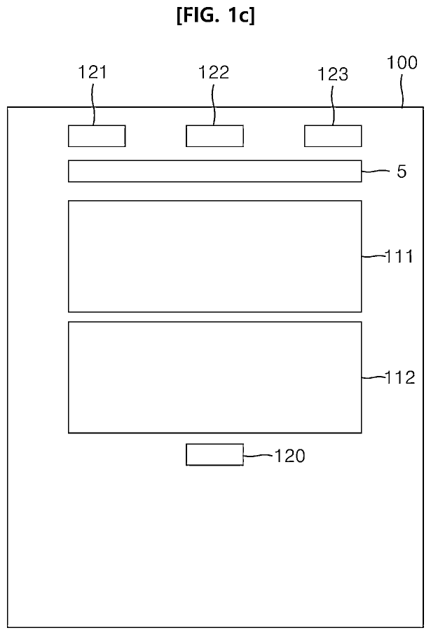

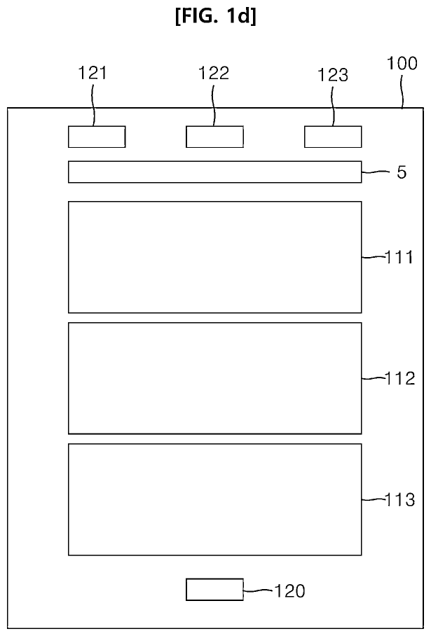

Hereinafter, it will be described with reference to FIGS. 1a to 1d, and FIGS. 1a to 1d may be collectively referred to as FIG. 1.

A user may execute an application program running on a computing device, provided according to an embodiment of the present disclosure.

The application program may express the same contents as those shown in FIGS. 1a to 1d on a monitor 100 of the computing device.

Reference numeral 121 denotes a drawing button 121. Reference numeral 122 denotes an information button 122. Reference numeral 123 denotes a result button 123. Reference numeral 120 denotes a map add button.

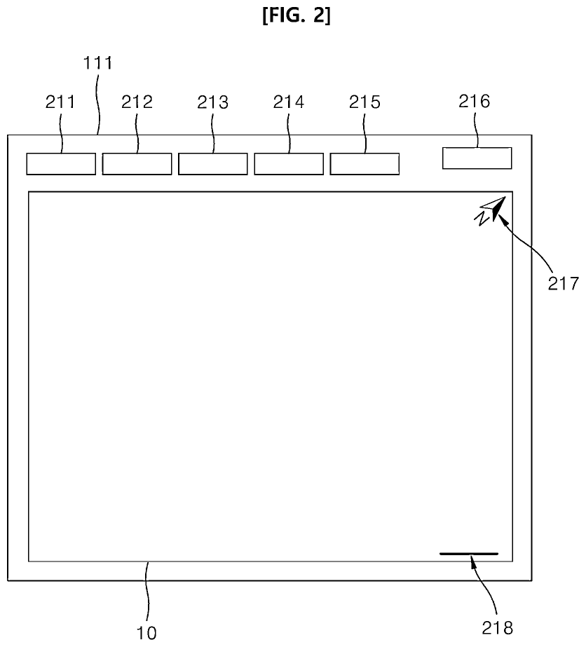

Reference numeral 5 denotes a node-link selection toolbar 5. The node-link selection toolbar 5 will be described in more detail with reference to FIG. 2.

Reference numerals 111, 112, and 113 denote map windows in which maps selected by the user executing the application program and expressed on the monitor 100 are displayed, respectively. Reference numeral 111 denotes a first map window 111 indicating an image of a first map selected by the user. Reference numeral 112 denotes a second map window 112 indicating an image of a second map selected by the user. Reference numeral 113 denotes a third map window 113 indicating an image of a third map selected by the user.

When the map add button 120 is clicked in FIG. 1a, a dialog box expressing map images stored in a file system is expressed on the monitor 100, and the user may select a first map among the map images. As a result, the first map may be expressed on the first map window 111 of the monitor 100 as shown in FIG. 1b. In addition, the map add button 120 may be displayed under the lowest map among the maps expressed on the monitor 100.

When the map add button 120 is clicked in FIG. 1b, a dialog box expressing map images stored in the file system is expressed on the monitor 100, and the user may select a second map among the map images. As a result, the second map may be expressed on the second map window 112 of the monitor 100 as shown in FIG. 1c. In addition, the map add button 120 may be displayed under the lowest map among the maps expressed on the monitor 100.

When the map add button 120 is clicked in FIG. 1c, a dialog box expressing map images stored in the file system is expressed on the monitor 100, and the user may select a third map among the map images. As a result, the third map may be expressed on the third map window 113 of the monitor 100 as shown in FIG. 1d. In addition, the map add button 120 may be displayed under the lowest map among the maps expressed on the monitor 100.

When the map add button 120 is continuously selected, a new map may be additionally expressed on the monitor 100. When the number of selected maps increases, all the selected maps may not be expressed on the monitor 100. In this case, the application program may browse all the selected maps by providing up and down scroll bars on the monitor 100.

FIG. 2 illustrates a detailed configuration of the first map window.

A plurality of regions exists in the first map window 111.

Reference numeral 211 denotes a text input box provided for the user to input a brief description of a map 10 displayed by the first map window 111. For example, the user may input a “first basement floor of Station 1” to the text input box.

Reference numeral 212 denotes a text input box provided for the user to input the number of floors represented by the map displayed by the first map window 111. For example, the user may input “B001” to the text input box.

Reference numeral 213 denotes a text input box provided for the user to input actual intervals between adjacent markers among markers automatically created by the application program on the map displayed by the first map window 111. For example, the user may input “10 m” to the text input box.

Reference numeral 214 denotes a text input box provided for the user to input the scale indicated by the map displayed by the first map window 111. For example, the user may input “20 m” to the text input box.

Reference numeral 215 denotes a text input box provided for the user to input a value indicating an angle between the direction indicating north on the map displayed by the first map window 111 and a vertical direction of the monitor 100. For example, the user may input “60 degrees” to the text input box.

Reference numeral 216 denotes a map delete button. When the user selects the map delete button 216, the first map window 111 disappears from the monitor 100. The button is selected when the user wants to delete the map that has already been inputted.

Reference numeral 217 denotes an arrow icon 217 indicating north. The application program may express the arrow icon by rotating it according to the value input into the text input box 215. For example, when the north direction of the map 10 displayed by the first map window 111 is a 12 o'clock direction when the monitor 100 is looked at, the user may input 0 degrees into the text input box 215, and in this case, the arrow of the arrow icon 217 may face the 12 o'clock direction when the monitor 100 is looked at. Alternatively, when the north direction of the map 10 displayed by the first map window 111 is a three o'clock direction when the monitor 100 is looked at, the user may input 90 degrees into the text input box 215, and in this case, the arrow of the arrow icon 217 may face the three o'clock direction when the monitor 100 is looked at. The user may repeatedly modify the number input to the text input box 215 so that the north direction expressed on the map 10 displayed by the first map window 111 coincides with the direction indicated by the arrow icon 217. The application program may recognize the north direction of the map 10 displayed by the first map window 111 based on the number input in the text input box 215.

Reference numeral 218 denotes a scale display portion 218 that displays the scale of the map 10 displayed by the first map window 111. The number input into the text input box 214 is expressed near the short and thick line displayed on the scale display portion 218. In this case, the scale may be displayed on the map 10 displayed by the first map window 111. The user may change the number input to the text input box 214 until the scale displayed on the map 10 coincides with the information displayed on the scale display portion 218. The application program allows the user to recognize the scale of the map 10 displayed by the first map window 111 based on the number input in the text input box 214.

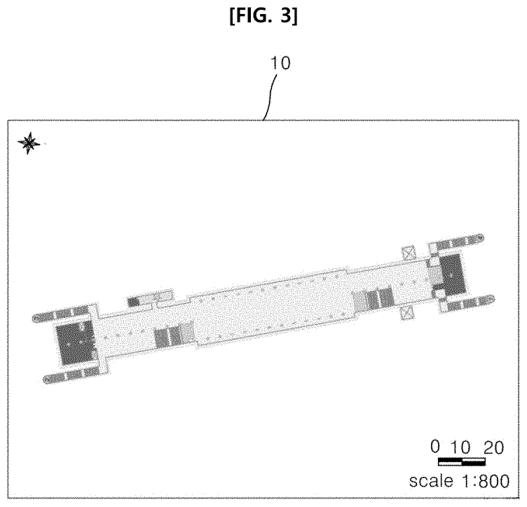

FIG. 3 is an image illustrating an example of the map 10 displayed by the first map window 111.

The example of the map 10 illustrated in FIG. 3 contains an image representing a specific floor of a subway station. FIG. 3 is, for example, the map 10 representing the first basement floor of a specific subway station.

The north direction of the map 10 is presented in the upper left of the map 10, and the scale of the map 10 is presented in the lower right of the map 10.

The arrow icon 217 and the scale display portion 218 may be displayed in an overlapped manner on the map 10.

The map 10 may be replaced by the user. For example, after selecting the map delete button 216 to delete the map 10, the user may press the map add button 120 to select a new map, and then express the selected new map in the first map window 111.

The application program may be provided such that the map 10 is not rotated on the monitor 100.

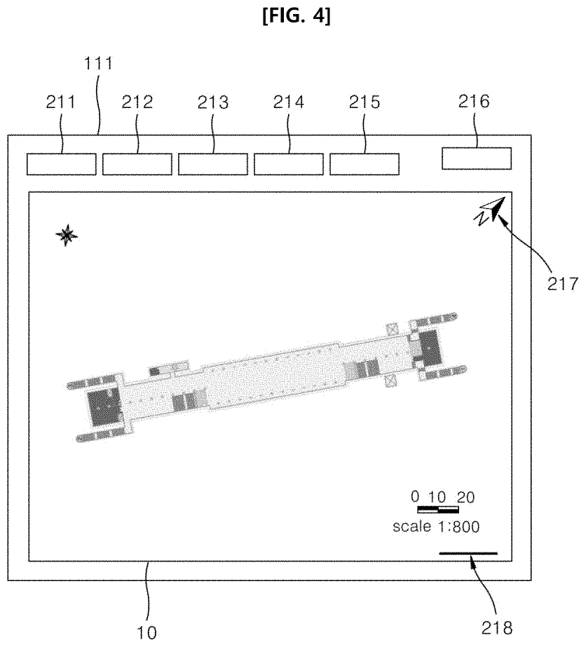

FIG. 4 illustrates a state in which the map 10, the arrow icon 217, and the scale display portion 218 are displayed on the first map window 111 in a state of being overlapped or superimposed.

An image displayed by the scale display portion 218 may be changed according to a number input by the user into the text input box 214. For example, when the horizontal length occupied by the map 10 on the monitor 100 is 50 cm, the actual horizontal length of the floor represented by the map 10 may be 50 m. In this case, the actual length of the floor indicated by 1 cm on the monitor 100 may be 1 m. At this time, the application program may recognize, with the number input into the text input box 214, the fact that, when the length occupied by one cell of the scale display portion 218 on the monitor 100 is 1 cm, the actual length of the floor indicated by one cell of the scale display portion 218 is 1 m. Then, the application program may display the information of 1 m next to one cell indicated by the scale display portion 218 of the monitor 100.

A user may select, as the map 10, a map representing one of various floors of a specific building. However, the actual horizontal and vertical lengths of the selectable floors may be different from each other; when the map of the selected floor is expressed as the map 10 on the monitor 100, the horizontal length of the map 10 may be fixed to a predetermined value on the predetermined monitor 100. In this case, the size of the actual floor represented by the map of the floor selected by the user may be acquired together when the user acquires the map of the floor. Accordingly, the user may manually input the acquired information on the scale of the map into the text input box 214.

The arrow icon 217 may be presented at the upper right of FIG. 4. An appropriate number may be input into the text input box 215 so that the direction indicated by the arrow icon 217 is the same as the direction indicated by the actual north of the floor displayed by the map 10.

The direction indicated by the arrow of the arrow icon 217 may be determined by a number input by the user into the text input box 215. In this case, information on the north of the map 10 may have already been presented in the upper left of the map 10.

Alternatively, the user may rotate the arrow icon 217 so that the north direction indicated by the arrow icon 217 is the same as the north direction displayed on the upper left of the map 10.

In an embodiment, when the user inputs a specific number into the text input box 215, the direction indicated by the arrow icon 217 is automatically changed. Alternatively, when a portion of the arrow icon 217 is selected with a mouse and the position value of the mouse is changed while clicking, the arrow icon 217 may rotate accordingly, and as a result, a value according to the rotation may be automatically input into the text input box 215. These functions may be provided by the application program.

The arrow icon 217 may be rotated by changing the user input within 360 degrees. The user has to know in advance which direction is north in the space represented by the map 10. The user may finely adjust an appropriate value for rotating the arrow icon 217 within a 360-degree range, and input the appropriate value into the text input box 215 in a trial and error manner. The arrow icon 217 may be a separate object distinct from the map 10.

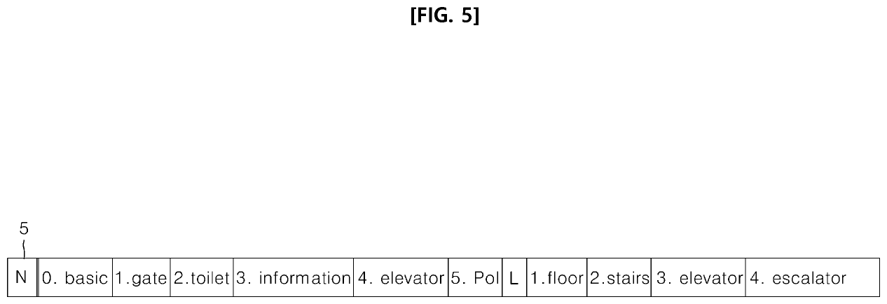

FIG. 5 illustrates a detailed configuration of a node-link selection toolbar.

In FIG. 5, “N” and “L” refer to nodes and links to be each disposed on the map 10 in a state of being overlapped by the user. The nodes and links may be displayed on the map 10 as straight-line icons made of squares and arrows, respectively.

The user may select the nodes and links by using the node-link selection toolbar 5 and dispose them on the map 10.

The nodes may be divided into a plurality of types. Integers “0” to “5” presented next to “N” in FIG. 5 indicate different types of nodes. For example, when the user clicks and selects “0” next to “N” with the mouse, a default node without properties is selected. Further, when the user clicks and selects “1” next to “N” with the mouse, a node with the property of “gate” is selected. Further, when the user clicks and selects “2” next to “N” with the mouse, a node with the property of “toilet” is selected. Further, when the user clicks and selects “3” next to “N” with the mouse, a node with the property of “information” is selected. Further, when the user clicks and selects “4” next to “N” with the mouse, a node with the property of “elevator” is selected. Further, when the user clicks and selects “5” next to “N” with the mouse, another node with a property of “point of interest (PoI)” is selected.

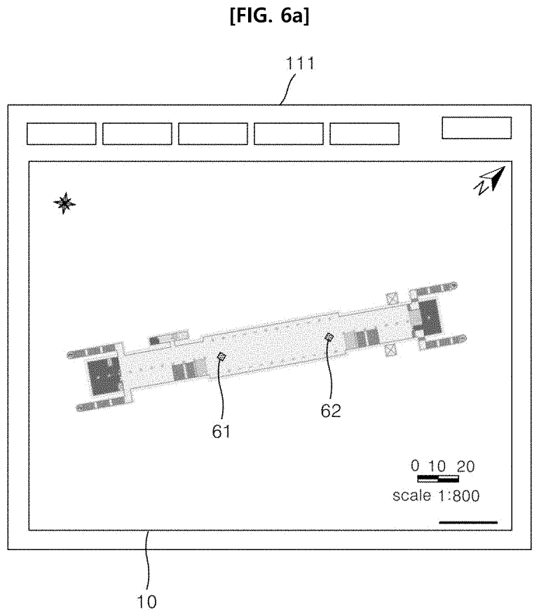

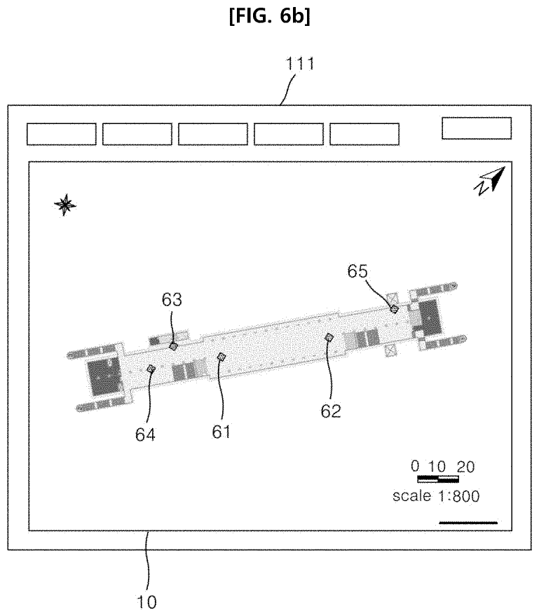

FIG. 6a illustrates an example of creating a total of two nodes 61 and 62 by clicking “0” next to “N” shown in FIG. 5 and then clicking each of two selected positions on the map 10, and expressing the two nodes on the map 10. The two created nodes are represented by a rhombus.

FIG. 6a illustrates an example of creating a toilet node 63 by clicking “2” next to “N” shown in FIG. 5 and then clicking a first point on the map 10, creating an information node 64 by clicking “3” next to “N” and then clicking a second point on the map 10, and creating an elevator node 65 by clicking “4” next to “N” and then clicking a third point on the map 10. In this case, the first point, the second point, and the third point for disposing the toilet node 63, the information node 64, and the elevator node 65 may be recognized by using predetermined information when the user acquires the first map.

Referring back to FIG. 5, the links may be divided into a plurality of types. The natural numbers from “1” to “4” presented next to L indicate different kinds of links. For example, when the user clicks and selects “1” next to “L” with the mouse, a link with properties of “walk way (floor)” is selected. Further, when the user clicks and selects “2” next to “L” with the mouse, a link with properties of “stairs” is selected. Further, when the user clicks and selects “3” next to “L” with the mouse, a link with properties of “elevator” is selected. Further, when the user clicks and selects “4” next to “L” with the mouse, a link with properties of “escalator” is selected.

The links are indicated by lines on the map 10. The link with the properties of “walk way” indicates that there is a flat ground on which a person is able to walk along the extended portion of the link. The link with the properties of “stairs” indicates that there is a staircase that a person is able to walk up or down along the extended portion of the link. The link with properties of “elevator” indicates that there is an elevator in which a person is able to ride along the extended portion of the link. The extension direction of the link with properties of “elevator” is only symbolic, and in reality, the elevator may move in a vertical direction. The link with properties of “escalator” indicates that there is an escalator in which a person is able to ride along the extended portion of the link.

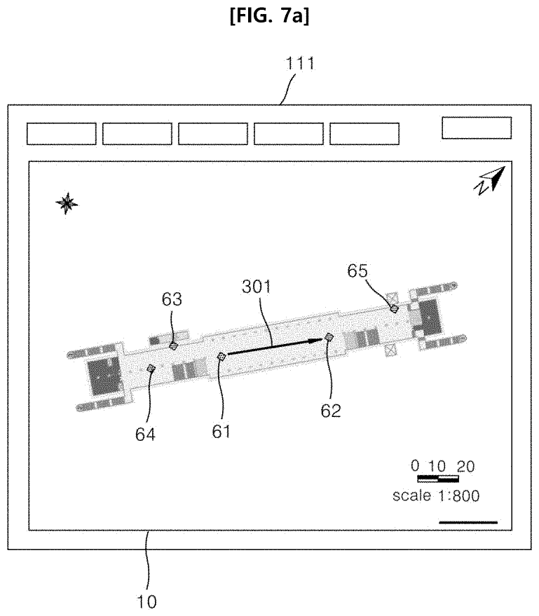

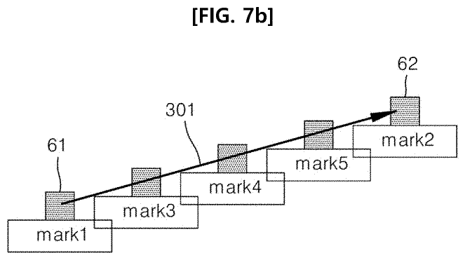

FIG. 7a illustrates an example of a result obtained by creating one link 301 with a direction between two nodes 61 and 62 by clicking “1” next to “L” shown in FIG. 5 and then successively clicking the two nodes 61 and 62 already created in the map 10 shown in FIG. 6b.

According to an embodiment of the present disclosure, when one link 301 is long enough, the application program may automatically create markers to be disposed on the link 301 according to a preset interval.

For example, the extension direction of the straight line indicated by the link 301 indicates the extension direction of a virtual route corresponding to the straight line on the real floor represented by the map 10. In fact, a line that may be distinguished by the eye is not painted on the route corresponding to the straight line indicated by the link 301 on the floor. Instead, markers may be attached to several points on the virtual route. Preferably, the interval between the markers is set to a value that allows a passer-by who has reached one marker to visually check another marker adjacent to the one marker. For example, if the distance between two adjacent markers is 200 m, a passer-by who has reached one marker may not be able to visually check another marker adjacent to the one marker.

The images of the markers created in this way may be actually printed on paper or a printing plate. A person may personally go to the actual floor and attach the printed result to the floor.

Of course, one marker is created corresponding to each of the nodes 61 and 62 manually created by directly pressing the number next to “N” as described above. The images of the markers created in this way may be actually printed on paper or a printing plate. A person may personally go to the actual floor and attach the printed result to the portions of the floor corresponding to the respective nodes 61 and 62.

The markers created in this way may be created manually or semi-automatically, but in an embodiment of the present disclosure, all markers may be automatically created. That is, images for all markers may be automatically created.

FIG. 7b illustrates markers to be attached to a pair of nodes connected to each other by one link in FIG. 7a and markers to be attached to a route between the pair of nodes.

mark1 and mark2 shown in FIG. 7b are marks to be attached at positions corresponding to the nodes 61 and 62, respectively.

mark3, mark4, and mark5 shown in FIG. 7b are marks to be attached to three positions on a route connecting the position of the node 61 and the position of the node 62.

The positions of the nodes 61 and 62 respectively corresponding to mark1 and mark2 are personally selected by the user on the map 10. In contrast, the positions on the floor where mark3, mark4, and mark5 have to be installed are not personally selected by the user, but are automatically determined by the application program.

In mark1 and mark2, the node 61 and the node 62, respectively, corresponding thereto exist. In contrast, corresponding nodes are not defined in mark3, mark4, and mark5. That is, the term node is a concept corresponding to a position personally selected by the user on the map 10.

Contrary to the above concept, if nodes corresponding to mark3, mark4, and mark5 are to be defined, the nodes have to be regarded as the second type of nodes automatically defined by the application program. Alternatively, the nodes 61 and 62 may be regarded as the first type of nodes.

The application program may automatically create images of mark1 to mark5. The created images of mark1 to mark5 may be printed on paper or other objects. The paper or other objects may be attached to corresponding positions on the floor.

The number of markers to be attached between the nodes 61 and 62 may vary depending on a marker interval preset by the user by using the application program. The marker interval may refer to an actual distance on the floor between two adjacent markers.

The marker interval may be effectively applied only to a first set of markers. The first set of markers refer to markers in which positions to which the markers are to be attached are not designated by the user, but are automatically designated by the application program. For example, in FIG. 7b, the first set of markers are mark3, mark4, and mark5.

The application program may regard the number input by the user into the text input box 213 as the marker interval.

The example shown in FIG. 7b corresponds to a situation in which the actual distance between mark1 and mark2 on the floor is 9 m, and the marker interval is set to 2.5 m.

Alternatively, when it is assumed that the actual distance between mark1 and mark2 on the floor is 9 m and the marker interval is set to 4.5 m, only one marker in total will be automatically created between mark1 and mark2.

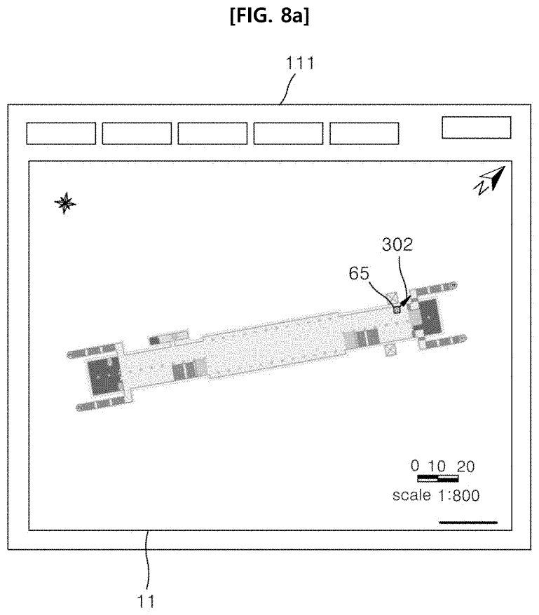

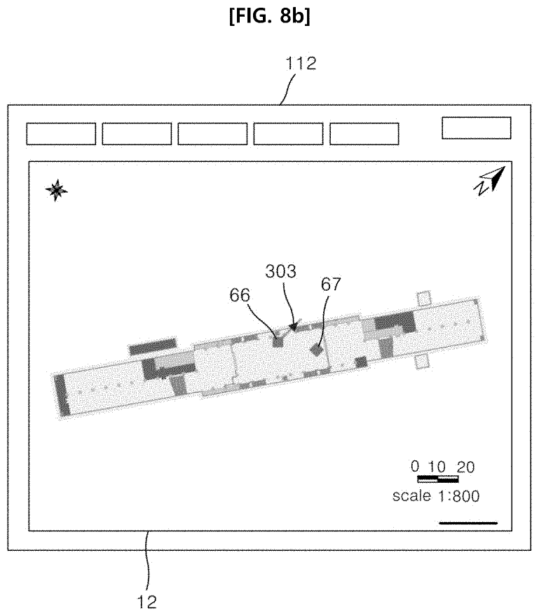

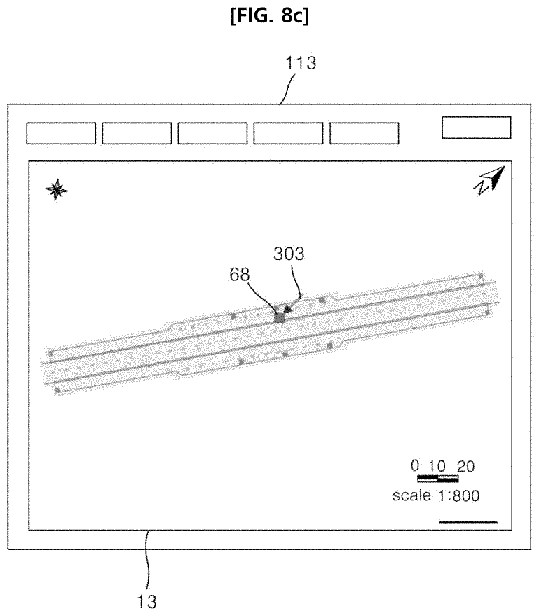

FIGS. 8a, 8b, and 8c illustrate a first basement floor, a second basement floor, and a third basement floor of a specific subway station, respectively.

FIGS. 8a, 8b, and 8c may be expressed on the first map window 111, the second map window 112, and the third map window 113 of FIG. 1d, respectively.

In FIG. 8a, a first map 11 showing the first basement floor of the subway station is presented in the first map window 111.

In FIG. 8b, a second map 12 showing the second basement floor of the subway station is presented in the second map window 112.

In FIG. 8c, a third map 13 showing the third basement floor of the subway station is presented in the third map window 113.

The subway station may have a first elevator connecting the first basement floor and a first floor on the ground. In the upper right of the map 10, a first-basement-floor door for the first elevator exists. FIG. 8a illustrates a state in which the user creates the node 65 in front of the first-basement-floor door for the first elevator.

Although not illustrated, the user may prepare an image of the first floor representing the first floor of the subway station. The user may further express the image of the first floor on the monitor 100 using the application program. In this case, the first-floor door for the first elevator exists in the upper right of the image on the first floor. In addition, the user may create a first-floor node in front of the first-floor door for the first elevator.

In this case, there is a vertical passage vertically connected by the first elevator between the node 65 and the first-floor node. Since the vertical passage is a route through which a passer-by is able to move, it may be regarded as one of the links described above.

When the user clicks “3” on the right of “L” in FIG. 5 and then successively clicks the node 65 and the first-floor node, a link 302 connecting the node 65 and the first-floor node is created and expressed. The link 302 is a link connecting different floors. In the present disclosure, different floors are expressed in different map windows. In addition, different map windows are spaced apart from each other in the vertical direction on the monitor 100. Therefore, when the link 302 is represented as a straight line directly connecting the node 65 and the first-floor node, the image expressed on the monitor 100 becomes complicated. Accordingly, in an embodiment, a link connecting different floors, such as the link 302 shown in FIG. 8a, may be represented by a short arrow originating from a node that exists at one end of the link, for example, the node 65.

Referring to FIGS. 8b and 8c, in consideration of a situation in which a second elevator is used to go up from the third basement floor to the second basement floor, the user may create a node 68 in front of the door for the second elevator on the third basement floor, and create a node 66 in front of the door for the second elevator on the second basement floor. In addition, the user may create a link 303 connecting the node 66 and the node 68.

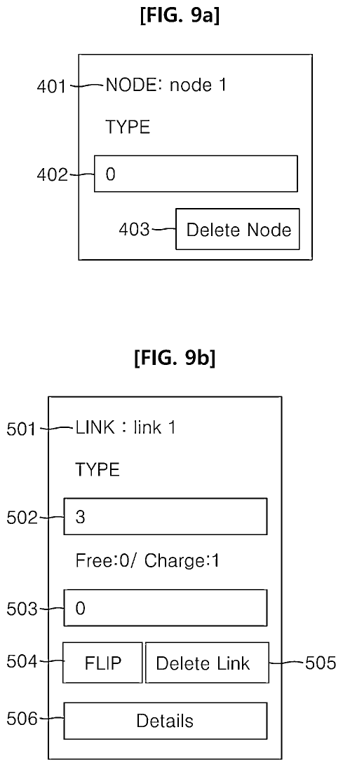

FIG. 9a is a diagram for describing information indicated by a sub-window expressed on the monitor when an arbitrary node that has already been created is clicked.

The information presented in FIG. 9a may be provided with an ID (e.g., node1) 401 of a node assigned by the application program to the node clicked by the user, a value 402 indicating the node type of the clicked node, and a button 403 for deleting the clicked node.

FIG. 9b is a diagram for explaining information indicated by a sub-window expressed on the monitor when an arbitrary link that has already been created is clicked.

The information presented in FIG. 9b may be provided with an ID (e.g., link1) 501 of the link assigned by the application program to the link clicked by the user, a value 502 indicating a link type of the clicked link, a value 503 indicating whether or not a toll fee has to be paid when a passer-by moves along the clicked link, a button 504 for changing the direction of an arrow indicating the clicked link, a button 505 for deleting the clicked link, and a button 506 for expressing detailed information about the clicked link.

When the clicked link and the toll gate intersect, the toll fee may have to be paid when a passer-by moves along the clicked link. To this end, the user may additionally create a toll line, which is an area occupied by toll gates, on the maps 11, 12, and 13. The application program may compare the coordinate information for the pay line with the coordinate information for the clicked link, and decide that the clicked link is the pay link when it is determined that there is a point where the pay line and the clicked link intersect.

When the user clicks the button 506 for expressing detailed information for the clicked link, the image presented in FIG. 7b may be expressed.

In the value 502 indicating the link type of the link, information such as 1. Walk way and 2. Stairs described in FIG. 5 may be displayed. For example, since the link 303 of FIG. 8b is 3. Elevator link, “3” may be displayed in the type box 502. The link type may be information automatically generated when the user creates the link.

When the user clicks the information button 122 presented in FIG. 1a, the information automatically generated by the application program when the user creates various nodes and links on the map may be expressed on the monitor, as described in FIGS. 6a, 6b, 7a, 8a, 8b, and 8c.

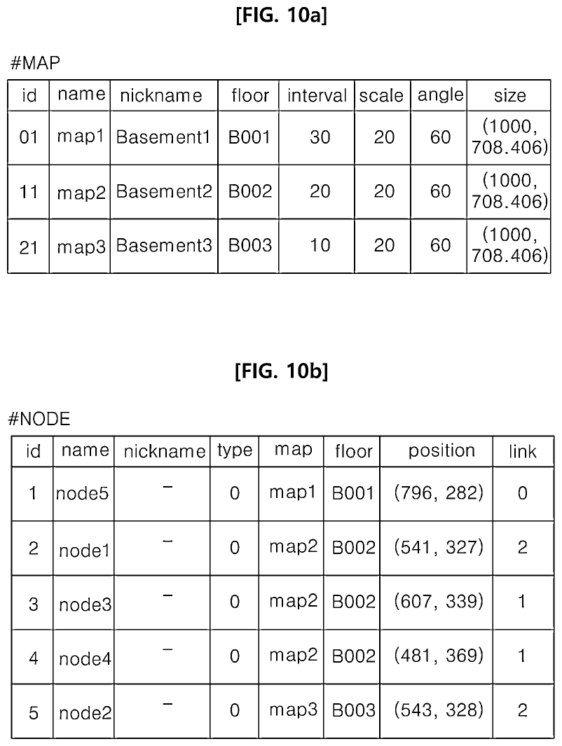

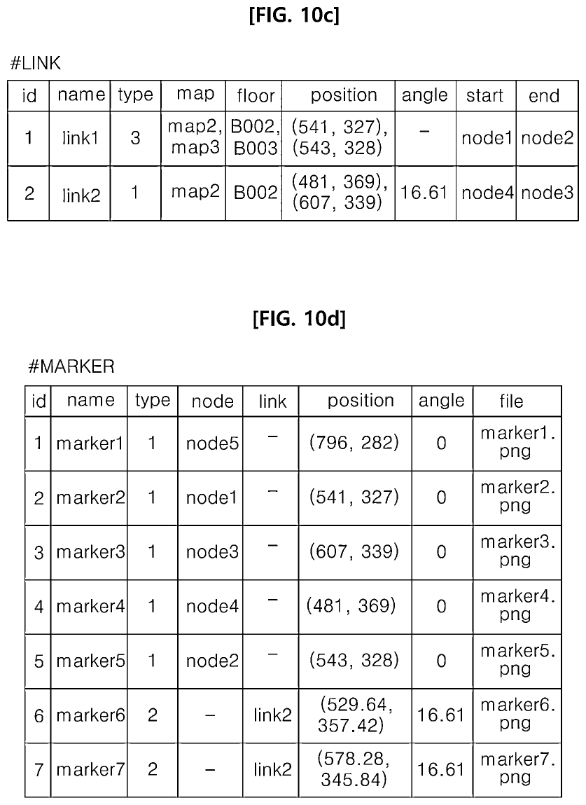

When the user creates various nodes and links on the map, the application program may automatically create the tables shown in FIGS. 10a, 10b, 10c, and 10d.

FIG. 10a is a table showing information on maps selected by the user. In FIG. 10a, it is assumed that the user has selected a total of three maps. An “id” column is a map ID automatically assigned to each of the three maps by the application program. A “name” column indicates the file name of each map when the user selects the map from the file system. A “nickname” column is information input by the user into the text input box 211. A “floor” column is information input by the user into the text input box 212. An “interval” column is information input by the user into the text input box 213. A “scale” column is information input by the user into the text input box 214. An “angle” column is information input by the user into the text input box 215. A “size” column is information indicating the bitmap size of each map.

FIG. 10b is a table showing information about each node created by the user. In FIG. 10b, it is assumed that the user creates a total of five nodes. An “id” column indicates an identifier automatically assigned by the application program to each node. A “name” column indicates a name automatically assigned by the application program to each node. A “nickname” column indicates a nickname automatically assigned by the application program to each node. A “type” column indicates a node type specified by the user when each node is created. A “map” column indicates a file name of the map where each node exists. A “floor” column indicates the floor number of each node exists. A “position” column indicates the position of each node on the map in pixels. A “link” column indicates the total number of links to which each node is connected.

FIG. 10c is a table showing information about each link created by the user. In FIG. 10c, it is assumed that the user creates a total of two links. An “id” column indicates an identifier automatically assigned by the application program to each link. A “name” column indicates a name automatically assigned by the application program to each link. A “type” column indicates the link type specified by the user when each link is created. A “map” column indicates a file name of the map to which each link is linked. In the case of a press link, only one map file name exists in the “map” column. However, in the case of an elevator link, file names of two maps corresponding to the two floors connected by the elevator link may exist together in the “map” column. A “floor” column indicates the floor number of each link that exists. A “position” column indicates positions of both ends of each link on the map in pixels. An “angle” column indicates an angle between the north direction and the straight line indicated by the link. In the case of the elevator link, the value of the “angle” column may not be defined. A “start” column indicates a starting node of each link. An “end” column indicates an end node of each link.

FIG. 10d is a table showing information on markers automatically created by the application program based on nodes and links created by the user. In FIG. 10d, it is assumed that the application program creates a total of seven markers. An “id” column indicates an identifier automatically assigned by the application program to each marker. A “name” column indicates a name automatically assigned by the application program to each marker. A “type” column indicates the type of each marker. A “node” column indicates a name of a node personally created by the user when the marker is associated to the node. A “link” column indicates a name of the link automatically created by the application program when the marker is associated with the link. A “position” column indicates a pixel position of each marker on the map.

The output marker image includes an arrow. An “angle” column indicates a direction of the arrow included in the output marker image. Up, down, left, and right are defined in the output marker image, and the “angle” indicates an angle of the arrow with respect to a vertically extending straight line.

The “type” of the marker associated with the node personally created by the user may be “1”. However, the “type” of the marker associated with the link automatically created by the application program may be “2”. That is, the marker associated with the node personally created by the user may be a first type of marker, and the marker associated with the link automatically created by the application program may be the second type of marker.

The “angle” of the marker (type=1) associated with the node personally created by the user may be all 0. However, the “angle” of the marker (type=2) associated with the link automatically created by the application program may have a non-zero value.

According to an embodiment of the present disclosure, in the case of the marker associated with the link automatically created by the application program, a person who actually attaches the printed marker to the floor has to attach the marker so that the vertically extending straight line of the marker image is parallel to the extending direction of the straight line indicated by the link associated with the marker. However, the problem is that the link is expressed as a straight line in the application program, but the link is not displayed on the floor in the actual floor. Accordingly, it is not possible to attach the marker so that the vertically extending straight line of the marker image is parallel to the extending direction of the straight line indicated by the link associated with the marker. Accordingly, the application program may, first, determine the “angle” value of the marker (type=2) based on the value indicating the north direction of the map (the value input in reference number 215), and the “angle” value of the link associated with the marker (type=2). In this case, an operator who actually attaches the marker to the floor may possess the compass. Further, when the operator attaches the marker with the arrow displayed on the marker coinciding with the direction indicated by the north direction of the compass, eventually, the vertically extending straight line of the marker may be made parallel to the extending direction of the straight line indicated by the link associated with the marker.

A “file” column of FIG. 10d indicates the file name of a file when each marker is stored as the file in the file system. All information in FIG. 10d is automatically created by the application program.

In an embodiment of the present disclosure, markers disposed on nodes have information corresponding to nodes one-to-one. However, markers automatically created at regular intervals on the link do not correspond to any created nodes. Instead, the markers correspond to the links where the markers are to be positioned. However, for any kind of marker, a pixel position on the map where the marker has to be disposed is specified.

When the user clicks the information button 122 shown in FIG. 1a, the tables shown in FIGS. 10a, 10b, 10c, and 10d may be expressed on the monitor.

Buttons for downloading and storing information for the corresponding tables may be provided next to the tables shown in FIGS. 10a, 10b, 10c, and 10d in the monitor.

The information included in the tables shown in FIGS. 10a, 10b, 10c, and 10d is sufficient information necessary for an algorithm in which the application program creates a route for guiding a passer-by to a destination. For example, a passer-by may visit a particular subway station. Further, the passer-by may stand on a specific node installed on a specific floor of the subway station. In addition, the passer-by may input a destination node among the nodes in the tables through an application program of his/her smartphone. The app of the smartphone may receive from the computing device information containing the nodes and the links designed according to the present disclosure, and information included in the four tables shown in FIGS. 10a, 10b, 10c, and 10d, for the specific subway station. In this case, the application program may decide an optimal route from a photographed marker to the destination by using the information included in the four tables. The algorithm for deciding the optimal route may be developed separately from the present disclosure.

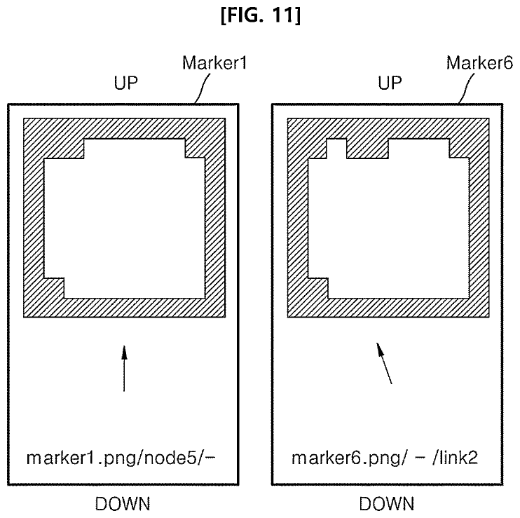

FIG. 11 illustrates an example of images of marker1 and marker6 among markers automatically created by the computing device based on information included in a marker table (#MARKER) presented in FIG. 10d.

Each of the markers of FIG. 11 may be presented as a pixel image in the form of a 10*10 matrix. The borders are all hatched, and the 7*8 matrix in the middle is not used to provide identification information about markers. In the 10*10 matrix, the band portion in the remaining 1 column except for the 7*8 matrix portion in the middle and the outermost portion contains the identification information about the markers.

A character string displayed at the lower part of each marker in FIG. 11 includes three pieces of information separated by two “/”s.

The first string is the name of the marker.png file.

The second string indicates the name of the node corresponding to the marker (type=1) in the case of a marker personally created by the user. When the second string is not null, the third string is given as null.

The third string indicates the name of the link corresponding to the marker (type=2) automatically created by the application program. When the third string is not null, the second string is given as null.

An arrow displayed on each marker in FIG. 11 is, for example, an arrow indicating the north direction. When each of the markers shown in FIG. 11 is attached to the floor, a compass may be placed next to the marker, and then fixed to the floor in a state of adjusting the posture of the marker so that the arrow displayed on the marker points to the north direction of the compass.

In the case of a marker personally created by the user, for the marker (type=1), the north direction indicated by the arrow does not need to coincide with the north direction indicated by the compass. However, in the case of the marker (type=2) automatically created by the application program, the north direction indicated by the arrow has to coincide with the north direction indicated by the compass.

Now, when the marker installed on the floor is photographed using a smartphone installed with an app for performing indoor navigation, a guide arrow may be displayed in a direction established along the links by a predetermined algorithm on the smartphone screen in a state of being overlapped on the photographed marker. In this case, the direction of the guide arrow displayed on the screen may be presented based on the north direction linked to the photographed marker.

The arrows and character strings displayed on the marker shown in FIG. 11 may be printed to be small so that only a person who attaches the marker on the floor is able to actually recognize it. Alternatively, in the marker, the portion on which the arrow and the character string are printed may be in the form of a sticker that may be removed after the marker is attached to the floor.

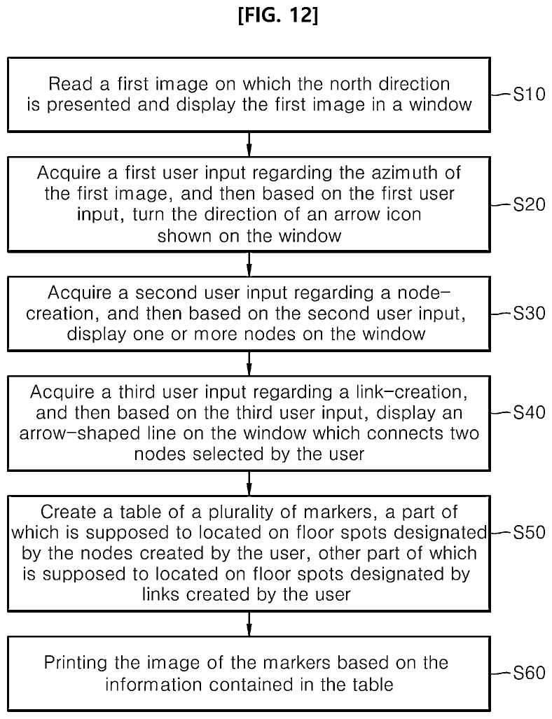

FIG. 12 is a flowchart showing a method for moving route planning and automatic marker making by a computing device, according to an embodiment of the present disclosure.

In step S10, the computing device may read a first image in which a north direction is marked to display the first image on a screen. Alternatively, the computing device may read the first image in which the north direction is marked to display the first image in a window (=map window). Here, the first image may be a map image. The map image may indicate a specific floor of a specific building.

In step S20, the computing device may acquire a user input regarding the azimuth to change a direction of an arrow icon displayed on the second map window based on the user input regarding the azimuth. Alternatively, the computing device may obtain a first user input regarding the azimuth of the first image, and then turn the direction of the arrow icon shown on the window based on the first user input.

In step S30, the computing device may acquire a user input regarding node creation to display two or more nodes on the screen based on the user input regarding the node creation. Alternatively, the computing device may obtain a second user input regarding node creation, and then display one or more nodes on the window based on the second user input.

In step S40, the computing device may acquire a user input regarding link creation to display, on the screen, an arrow-shaped link connecting between two selected nodes disposed on the screen based on the user input regarding the link creation. Alternatively, the computing device may acquire a third user input regarding link creation, and then display one arrow-shaped line connecting two nodes selected by the user on the window based on the third user input.

In step S50, the computing device may create a table of two or more markers to be disposed on an indoor floor indicated by the two or more nodes, and one or more markers to be disposed on the indoor floor indicated by the link at preset intervals. Alternatively, the computing device may create a table of a plurality of markers, some of which are to be disposed on floor spots designated by the nodes created by the user, others of which are to be disposed on floor spots designated by the links created by the user.

In step S60, the computing device may output the respective markers in the form of images based on the information included in the table. Alternatively, the computing device may print the images of the markers based on the information included in the table.

PCT/KR2019/006610 discloses a function and a configuration of a user device used by a passer-by. The markers created according to an embodiment of the present disclosure may be used as objects to be recognized by a camera installed in the user device. The structure of the algorithm for deciding the boundary shapes of the hatched areas shown in FIG. 11 is not directly related to the idea to be protected in the present disclosure. However, the boundary shapes of different markers have different shapes.

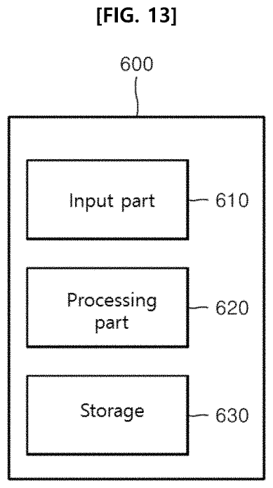

FIG. 13 is a block diagram of a computing device according to an embodiment of the present disclosure.

The computing device 600 may include an input part 610, a processing part 620, and a storage device 630.

The input part 610 may be configured to receive an azimuth, node creation, and link creation from the user.

The processing part 620 may read the first map in which a north direction is marked to display the first map on the monitor. The processing part 620 may change a direction indicated by the arrow icon to be displayed on the monitor based on the user input regarding the azimuth. The processing part 620 may display two or more nodes to be overlapped on the first map based on the user input regarding the node creation. Further, the processing part 620 may display the arrow-shaped link connecting between two nodes disposed on the monitor in a state of being overlapped on the first map based on the user input regarding the link creation. The processing part 620 may create the table of the first type of markers respectively corresponding to the two or more nodes displayed in a state of being overlapped on the first map and the second type of markers corresponding to the link displayed in a state of being overlapped on the first map. The processing part 620 may output the first type of markers and the second type of markers in the form of an image file based on information included in the table to store the output markers in the storage device.

In addition, the processing part 620 may be configured to execute steps performed in the above-described computing device.

According to the present disclosure, it is possible to provide a tool executed on a computing device for establishing a moving route plan indoors. In addition, it is possible to provide a tool capable of automatically creating many markers to be attached on such a moving route.

What is claimed is:

1. A method for moving route planning and marker automatic making, comprising:
reading, by a computing device, a first map in which a north direction is marked to display the first map on a monitor;
acquiring, by the computing device, a user input regarding an azimuth to change a direction indicated by an arrow icon to be displayed on the monitor based on the user input regarding the azimuth;
acquiring, by the computing device, a user input regarding node creation to display two or more nodes in a state of being overlapped on the first map based on the user input regarding the node creation;
acquiring, by the computing device, a user input regarding link creation to display an arrow-shaped link connecting between two nodes disposed on the monitor in a state of being overlapped on the first map based on the user input regarding the link creation;
creating, by the computing device, a table of a first type of markers respectively corresponding to two or more nodes displayed in the state of being overlapped on the first map and a second type of markers corresponding to links displayed in the state of being overlapped on the first map; and
outputting, by the computing device, the first type of markers and the second type of markers in a form of an image file based on information included in the table to store the output markers in a storage device.

2. The method of claim 1, wherein an object on which any of the first type of markers and the second type of markers are printed is installed on a floor of an indoor space indicated by the first map, and
the user input regarding the link creation is to sequentially click the two nodes displayed on the monitor.

3. The method of claim 1, wherein the markers outputted in the form of the image file includes a pixel image in a form of a predetermined matrix, an arrow indicating a north direction, and a character string.

4. The method of claim 3, wherein the pixel image includes identification information about the markers in a band portion of one predetermined column except for an outermost portion.

5. The method of claim 3, wherein the character string includes a name of a marker, and information about a node or link corresponding to the marker.

6. The method of claim 1, wherein the table includes information on at least one of a name, a type, and information on a corresponding node or link for each of the markers, a pixel position on the first map, and a rotation angle of the marker.

7. The method of claim 1, wherein when the table is created, a table for one or more maps including the first map, a table for the two or more nodes, and a table for the link are further created.

8. The method of claim 7, wherein the table includes information on at least one of names, nicknames, floors, preset intervals, scales, and the azimuths for the one or more maps, and sizes of the maps.

9. The method of claim 7, wherein the table for the two or more nodes includes information on at least one of a name and type of each of the nodes, a name of a map in which the node is created, a floor on which the node is disposed, a pixel value indicating a position on which a center of the node is disposed, and a total number of links connected to the node.

10. The method of claim 7, wherein the table for the link includes information on at least one of a name and type of the link, a name of a map on which the link is disposed, a floor on which the link is disposed, coordinates of the two nodes that the link connects, an angle at which an arrow head of the link is spaced apart from the north direction, a name of a node from which the link originates, and a name of a node from which the link arrives.

11. The method of claim 1, wherein the first map is display on a first map window of the monitor, and
the method further comprises:
reading, by the computing device, a second map in which a north direction is marked to display the second map on a second map window of the monitor;
acquiring, by the computing device, the user input regarding the azimuth to change a direction of an arrow icon displayed on the second map window based on the user input regarding the azimuth;
acquiring, by the computing device, the user input regarding the node creation to display a first node in a state of being overlapped on the first map and display a second node in a state of being overlapped on the second map, based on the user input regarding the node creation; and
acquiring, by the computing device, the user input regarding the link creation to display an arrow-shaped second link connecting between the selected first node and the second node that are disposed on the first map window expressing the first map and the second map window on the monitor in a state of being overlapped on the first map and the second map, respectively, based on the user input regarding the link creation.

12. The method of claim 1, further comprising, before the creating of the table,
acquiring a user input regarding free or paid depending on whether a gate for which a fee has to be paid exists within a range of an indoor space indicated by the link to change information about the link.

13. The method of claim 1, wherein a type of user input regarding the node creation includes a basic node, a gate node, a toilet node, an information node, an elevator node, and other nodes, and
a type of user input regarding the link creation includes a sidewalk link, a stair link, an elevator link, and an escalator link.

14. A computing device comprising:
an input part;
a processing part; and
a storage device, wherein the input part is configured to receive an azimuth, node creation, and link creation from a user, and
the processing part is configured to perform operations comprising:
reading a first map in which a north direction is marked to display the first map on a monitor;
changing a direction indicated by an arrow icon to be displayed on the monitor based on a user input regarding the azimuth;
displaying two or more nodes in a state of being overlapped on the first map based on a user input regarding the node creation;
displaying an arrow-shaped link connecting between two nodes disposed on the monitor in a state of being overlapped on the first map based on a user input regarding the link creation;
creating a table of a first type of markers respectively corresponding to the two or more nodes displayed in the state of being overlapped on the first map and a second type of markers corresponding to the link displayed in the state of being overlapped on the first map; and
outputting the first type of markers and the second type of markers in a form of an image file based on information included in the table to store the output markers in the storage device.

15. A non-transitory computer-readable recording medium having a program recorded thereon, the program including command codes that cause a computing device to plan a moving route and automatically create a marker, wherein the command codes, when executed, cause to the computing device to perform operations comprising:
reading a first map in which a north direction is marked to display the first map on a monitor;
acquiring a user input regarding an azimuth to change a direction of an arrow icon to be displayed on the monitor based on the user input regarding the azimuth;
acquiring a user input regarding node creation to display two or more nodes in the state of being overlapped on the first map based on the user input regarding the node creation;
acquiring a user input regarding link creation to display an arrow-shaped link connecting between two nodes disposed on the monitor in the state of being overlapped on the first map based on the user input regarding the link creation;
creating a table of a first type of markers respectively corresponding to the two or more nodes displayed in a state of being overlapped on the first map and a second type of markers corresponding to the link displayed in a state of being overlapped on the first map; and
outputting the first type of markers and the second type of markers in a form of an image file based on information included in the table to store the output markers in a storage device.
